(19) United States
(12) Patent Application Publication
(10) Pub. No.: US 2007/0186251 A1
(43) Pub. Date: Aug. 9, 2007

(54) Emergency satellite network

(76) Inventors: Edward D. Horowitz, New York, NY (US); Robert K. Phelan, West Windsor, NJ (US); Christopher John Kean, Freehold, NJ (US)

Correspondence Address: THELEN REID BROWN RAYSMAN & STEINER LLP, 900 THIRD AVENUE, NEW YORK, NY, 10022, US

(21) Appl. No.: 11/346,638

(22) Filed: Feb. 3, 2006

(51) Int. Cl. H04N 7/16

(52) U.S. Cl. 725/63; 725/73; 725/62

(57) ABSTRACT

An emergency satellite communications system that provides remote sites with assured access. The network is provisioned, configured, and managed such that the remote units are always online, but not used to an extent that would prevent remote units from communicating via the network upon demand. The network may include geographic hub diversity to protect against hub failure. Proactive monitoring of the components comprising the network is used to mitigate or prevent network congestion, such as by load balancing. An overflow link may be provided, allowing for remote sites to be assigned from a first link to the overflow link to mitigate or prevent congestion on the first link, and/or allow for additional bandwidth to be allocated to one or more remote sites that remain on the first link. A satellite communication network may comprise a satellite and a network management system operative in controlling and managing a plurality of first and second terminals. A first earth station may be communicatively coupled to one or more terrestrial communications networks, where the first earth station provides a first communication link via the satellite for bidirectional communication between the first earth station and the plurality of first terminals assigned to the first earth station by the network management system. A second earth station may be geographically diverse from the first earth station and is communicatively coupled to at least one terrestrial communications network. The second earth station may provide a second communication link via the satellite for bidirectional communication between the second earth station and the plurality of second terminals assigned to the second earth station by the network management system.

### COPYRIGHT AND LEGAL NOTICES

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### BACKGROUND OF THE INVENTION

1. Field of the Invention

The present invention relates to satellite communication networks and, more particularly, to a satellite network that provides for assured access by remote units, even under emergency situations such as those due to severe weather, natural disasters, or other catastrophic events.

2. Background Art

The emergence and development of broadband communication systems has rapidly increased in recent years. Public switched telephone networks employing high-speed fiber optic communication, cellular mobile voice and data communications, and other network topologies and protocols such as Voice Over IP (VoIP) are some of many technologies that are relied upon for personal and business use.

Although these conventional communication technologies are an information lifeline in our everyday lives, many circumstances may deny access to this communication infrastructure. For example, the occurrence of a natural disaster (e.g., flooding) may cripple both cellular and terrestrial based communication systems. In such circumstances, loss of basic communications to homes and businesses in a disaster-struck area may deprive basic access to emergency services and other organizations (e.g., homeland security, counter-terrorist unit) that may be associated with responding to the crisis.

Satellite communication networks may provide a reliable communication platform for providing video, data, and voice communications in the event of an incapacitated communication infrastructure that may have suffered from, for example, excess structural damage due to natural or intentional occurrences (e.g., terrorist attack, flooding, hurricanes, etc.).

Although current satellite systems, among other things, provide a redundant communication infrastructure for disaster recovery and emergency situations, many issues concerning the reliability of satellite systems exist. For example, during events such as an emergency, data congestion or network bottlenecks may occur as a result of a sudden influx of satellite system users trying to access the satellite network. By exceeding the bandwidth capacity of the satellite network, a user may be deprived of satellite network use in a life-threatening emergency situation.

Another problem may occur based on a lack of redundancy considerations in satellite system networks. If a portion or network segment within a satellite communication system fails, the satellite communication system's capability as a redundant communication means could be rendered ineffective.

Still other limitations may relate to satellite mobile solutions incorporated within vehicles being rendered inoperable if their mobility is hindered in the aftermath of, for example, a natural disaster such as an earthquake, hurricane, or flood. In such situations, the mobile unit may be restricted in its mobility due to road closures and the general devastation caused by, for example, a natural disaster.

There remains a need, therefore, for further improvements and advances in satellite communication systems and, more particularly, in satellite communication systems that are capable of providing reliable communications under a variety of network failure conditions and emergency situations.

### SUMMARY OF THE INVENTION

The present invention provides, inter alia, embodiments of an emergency satellite communications network that provides remote sites with a high degree of assured access. Embodiments of the network are provisioned, configured, and managed such that the remote units are always online, but not used to an extent that would prevent remote units from communicating via the network upon demand. In some embodiments, the network may include geographic hub diversity to protect against hub failure. Proactive monitoring of the components comprising the network may be used in some embodiments to mitigate or prevent network congestion, such as by load balancing. Embodiments may also provide an overflow link, allowing for remote sites to be assigned from a first link to the overflow link to mitigate or prevent congestion on the first link, and/or allow for additional bandwidth to be allocated to one or more remote sites that remain on the first link.

In accordance with an aspect of the present invention, a satellite communication network comprises a satellite and a network management system operative in controlling and managing a plurality of first terminals and a plurality of second terminals. A first earth station may be communicatively coupled to one or more terrestrial communications networks, where the first earth station provides a first communication link via the satellite for bidirectional communication between the first earth station and the plurality of first terminals assigned to the first earth station by the network management system. A second earth station may be geographically diverse from the first earth station and is communicatively coupled to at least one of the terrestrial communications networks. The second earth station may provide a second communication link via the satellite for bidirectional communication between the second earth station and the plurality of second terminals assigned to the second earth station by the network management system.

According to another aspect of the present invention, the second earth station may further provide a third communication link, where one or more of the first and second terminals may be capable of being reassigned to the third communication link. Additionally, the first and second earth stations may include protocol processors, and one or more of the first and second terminals may be reassigned to the third link in the event that the protocol processor usage exceeds a predetermined threshold. One or more of the first and second terminals may be assigned to the third communication link to provide guaranteed access with assured quality of service to the first link by each of the remaining first terminals, such that each of the remaining first terminals may be assured of bidirectional communication over the one or more terrestrial communications networks.

According to another aspect of the present invention, each of the first and second earth stations is communicatively coupled to each of the one or more terrestrial communications network by a plurality of gateways, and in the event that one of the plurality of gateways is non-operational, a communication path is capable of being rerouted to an operational gateway.

According to another aspect of the present invention, operation of the satellite communication network is proactively monitored. Each of the first and second earth station may include at least one protocol processor, and monitoring includes monitoring of each of the protocol processor CPU utilization. Proactive monitoring may include monitoring of inbound and outbound bandwidth for each terminal in the network, and/or monitoring of alarm conditions of each terminal in the network, and/or monitoring the status of intemetworking systems for coupling the earth stations to the terrestrial networks.

According to yet another aspect of the invention, each terminal may be mobile, fixed, or portable, and may be associated with any of a variety of one or more devices or networks that may be configured for connection to the satellite communications network through a given modem. A terminal may join the network provided it has a modem and associated uplink/downlink equipment that is capable of interfacing and communicating with the satellite network according to predetermined specifications. Subscriber devices at the terminal that are used for communicating via the network may also be required to meet the network requirements.

According to still another aspect of the present invention, the terminals may comprise a transceiver providing for bidirectional communication via the first communication link. A computer operative in presenting a user interface allows for a user at the terminal to communicate via the first communication link. The terminals may also include a local storage and at least one VoIP port to provide VoIP communication via the first communication link. A local broadband wireless network access port provides for authorized devices within range of the wireless network access port to communicate with the one or more terrestrial communication network via the first communication link and with each other. A security module may be operative in authenticating devices for communication via the wireless network access port. A locally stored configuration profile is remotely accessible and reconfigurable by the network management system.

According to another aspect of the present invention, each terminal may further include a battery that is capable of supplying the power requirements of the terminal. Additionally, a manually operated generator that is capable of supplying the power requirements of each of the terminals may be provided. Each of the fixed stations may be portable.

In accordance with another aspect of the present invention, the station is operative in receiving private video content via said satellite network, storing said content on the local storage, and serving the private video content to devices via the local broadband wireless network access port.

In accordance with a further aspect of the present invention, a satellite communication network comprises a satellite, a network management system operative in controlling and managing a plurality of terminals, and an earth station providing a first communication link via the satellite for bidirectional communication between the earth station and the plurality of terminals assigned to the first earth station by the network management system, and a second communication link under control of the network management system, wherein one or more of the terminals are capable of being reassigned to the second communication link by the network management system.

In accordance with still another aspect of the present invention, a method for providing a satellite communications network comprises providing dedicated bandwidth on one or more satellites for the satellite communications network, and providing a subscriber to the satellite communications network with access to the network such that the subscriber has a disincentive for using the satellite communications network. In some implementations, the subscriber is provided with a limited bandwidth relative to other communications networks over which the subscriber may communicate, thereby providing the disincentive. The limited bandwidth may be increased in response to a demand, which demand may be based on a subscriber initiated request or on subscriber usage detected by the system. Alternatively or additionally, the subscriber is provided with access to the network according to a usage based fee structure, which provides a disincentive for usage. The usage based fee structure may be established relative to the cost of other communications network services providers that may be available to the subscriber, thereby providing the disincentive.

In accordance with a further aspect of the invention, a method for providing a satellite communications network comprises providing dedicated bandwidth on one or more satellites for the satellite communications network, providing a subscriber to the satellite communications network with access to burstable bandwidth, and charging the subscriber according to a usage based fee structure for burstable bandwidth.

In accordance with a yet a further aspect of the invention, a method for providing a satellite communications network comprises providing dedicated bandwidth on one or more satellites for the satellite communications network, providing a subscriber to the satellite communications network with access to burstable bandwidth, wherein the subscriber is initially provisioned with a limited bandwidth relative to other communications networks over which the subscriber may communicate, and wherein the subscriber is provided with increased bandwidth in the event of an indication that the subscriber demands additional bandwidth for communications.

In accordance with a further aspect of the invention, a method for providing a satellite communications service comprises providing dedicated bandwidth on one or more satellites for the satellite communications network, allocating bandwidth to each of a plurality of subscribers up to a maximum total bandwidth less than the dedicated bandwidth; and pricing usage of bandwidth by the subscribers as a disincentive for usage of the satellite communications service. Additional bandwidth may be provided to each subscriber on demand. Pricing may include billing subscribers according to bandwidth usage.

In accordance with a further aspect of the invention, in a satellite communication network comprising first and second communication links, each providing for bidirectional communication with a remote terminal via a modem in the remote terminal, a method for moving the remote terminals from the first communication link to the second communication link comprises storing information in the remote terminal providing for the remote terminal to communicate via the second link, and loading the information into the modem of the remote terminal in the event that the remote terminal loses communication via the first link.

Additional aspects of the present invention will be apparent in view of the description that follows.

### BRIEF DESCRIPTION OF THE FIGURES

The invention is illustrated in the figures of the accompanying drawings, which are meant to be exemplary and not limiting, and in which like references are intended to refer to like or corresponding parts.

FIG. 1 depicts an illustrative satellite communication network, in accordance with an embodiment of the present invention;

FIG. 2 depicts an illustrative remote site, in accordance with an embodiment of the present invention;

FIG. 3 is an operational flow diagram illustrating a sequence of events that occur in moving a remote site to an overflow link, in accordance with an embodiment of the present invention;

FIG. 4 depicts another illustrative satellite communication network, in accordance with an embodiment of the present invention; and

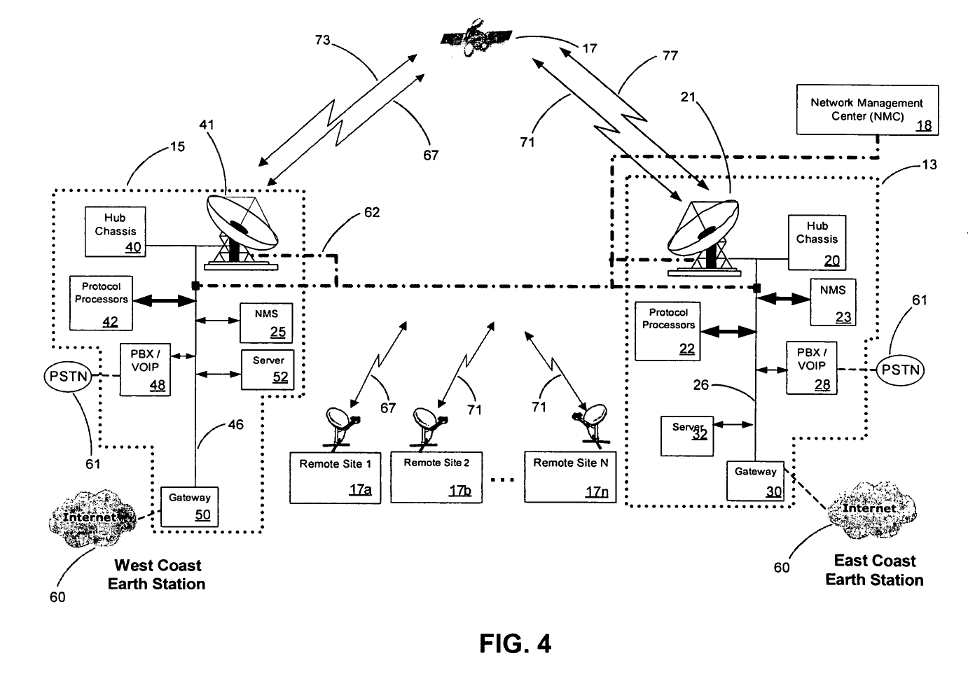

FIG. 5 depicts an illustrative process flow for installing remote sites, in accordance with some embodiments of the present invention.

### DETAILED DESCRIPTION

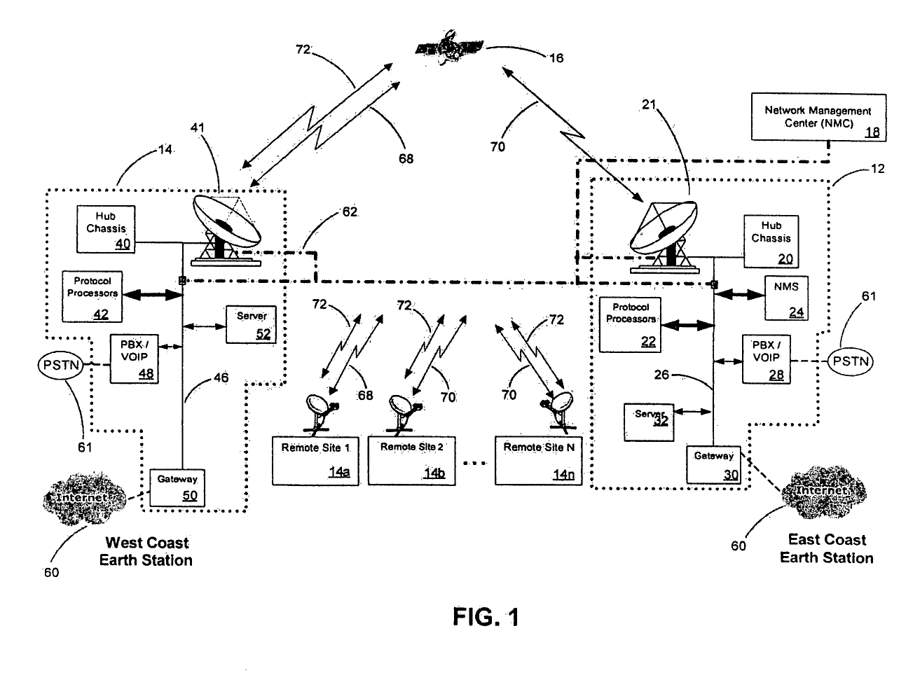

FIG. 1 depicts an illustrative satellite communication network within which the present invention may be embodied. In this embodiment, the satellite communications network is implemented as an IP network that provides subscribers with voice, data, and video communications. The network includes earth stations 12 and 14, multiple (n) remote sites 14a, 14b . . . 14n, satellite 16, and network management center (NMC) 18. As will be further understood from the ensuing description, the network may include additional earth stations and satellites.

Earth station 12 includes antenna station 21, hub chassis 20, protocol processors 22, network management system 24, voice over IP(VoIP)/PBX (private branch exchange) gateway 28, gateway 30, and server 32, each communicatively coupled via local network 26 (e.g., Ethernet). Earth station 14 includes corresponding components, namely, antenna station 41, hub chassis 20, protocol processors 22, network management system 24, private branch exchange 26, VoIP/PBX gateway 28, gateway 30, and server 32, each also communicatively coupled via local network 46. Below, each of these components is described with respect to earth station 12, and it will be understood that similar functionality applies to the corresponding components in earth station 14, with particular differences being described.

Hub chassis 20 includes modems that provide an intermediate frequency (IF) connection to antenna station 21, which includes an IF/RF converter for transmission to and reception from satellite 16 via a radio frequency link 70. As depicted, hub chassis 40 provides for transmission to and reception from satellite 16 via radio frequency link 68 as well as an additional link 72 (referred to hereinbelow as overflow link). Each of links 68, 70, and 72 represents both the outbound (from earth station to remote) and inbound (from remote site to earth station) frequency channels used to communicate with remote sites assigned to the links. In this embodiment, TDMA access is employed, with each link 70 including multiple (e.g., 9) time division multiplexed inbound frequency channels and one outbound frequency channel.

Protocol processors 22 and protocol processors 42 provide network services for a single IP network comprising links 68, 70, and 72 under management of NMS 24. In particular, in various embodiments, each protocol processor provides network services such as dynamic assignment of available inroute bandwidth (e.g., based on a fairness algorithm), IP routing to all line cards (on which the modems reside) in the hub chassis, IP multicast support, hub side control for Transmission Control Protocol (TCP) optimization over a satellite link, automatic adjustment of transmit power to maintain a low Bit Error Rate (BER) through the satellite link, Quality of Service (QoS) and traffic prioritization, and may also provide downstream committed information rate (CIR), firewall functions (e.g., using Access Control Lists (ACL)), and link encryption to all or selected sites (e.g., using Triple Data Encryption Standard (3DES)). The system automatically redistributes the communication load over the available protocol processors.

Network management system (NMS) 24 provides network administration functionality with visibility into a level of network resources that may be differently configured. Network resources managed by the NMS include all configurable aspects of the communication system including, for example, remote user equipment, line cards, the hub modem chassis, and the protocol processors. The NMS includes a database that stores configuration parameters and privileges for each resource in the communication system. For each of the remotes, this configuration information may be represented as an options file, which includes information concerning uplink and downlink frequency assignments, Class of Service (CoS) (e.g., inbound and outbound data rate), and committed information rate (CIR). Through NMS, an operator at earth station 12 or at a remote location with private network access to NMS 24 (e.g., at Network Management Center 18) may update a remote site options file and send the updated options file to the remote site.

Network Management Center 18, which may be located at a site remote from both earth stations 12 and 14, provides a central location where operators can manage network 10, as well as other satellite communications networks (not shown) via their network management systems. NMS 24 is configured to automatically communicate various alarm conditions directly to NMC 18. NMC 18, earth station 12 (including antenna station 21), and earth station 14 (including antenna station 41) are communicatively coupled via backbone network 62 (e.g., a fully protected SONET ring). As will be further understood below, such alarms include protocol processor CPU usage beyond predefined thresholds, individual remote units exceeding threshold bandwidth limitations, individual remote units or components thereof being inoperable, or non-responsive (e.g., in response to periodic pings from NMS, which may be invoked from NMC 18).

Server 32 schematically represents one or more servers (e.g., a multi-server environment) and associated databases that may be provided for various applications, such as providing an emergency network portal for subscribers at the remote sites, video distribution (e.g., on demand) for the remote sites, monitoring of individual remote site bandwidth usage (e.g., using a packet sniffer) for proactive load distribution, monitoring and recording of individual remote site bandwidth usage for billing purposes (e.g., usage based billing), a firewall, and authentication/security.

Gateways 30 and 50 are provided to connect the satellite communications network to the Internet 60. Voice communications from the remote sites may be routed to the public switched telephone network (PSTN) 61 via VoIP/PBX gateways 46 and 48, or alternatively, may be routed to the Internet 60 as a VoIP call via gateways 30 and 50. In a preferred embodiment of the invention, a remote site will be unable to receive calls originating outside the network.

In various embodiments, each remote site 14a, 14b . . . 14n represents a separate terminal or node having access to the satellite communication network, each of these terminals or nodes being mobile, fixed, or portable and being associated with any of a variety of one or more devices or networks that may be configured for connection to the satellite network through a given modem. A given entity (e.g., individual, company, etc.) may have more than one terminal or node. It is understood that in some embodiments, each terminal or node need not have identical devices or equipment. Rather, an entity may subscribe to, and be placed onto, the network provided the entity has a modem and associated uplink/downlink equipment that is capable of interfacing and communicating with the satellite network according to predetermined specifications. More specifically, in some embodiments, to join the network, a user may need to meet minimum specifications set by the network owner/operator, such minimum specifications including, for instance, the following: modem specifications; antenna transmit gain; antenna receive gain; antenna cross pole isolation; FCC (Federal Communications Commission) side lobe specifications; block up converter gain and phase noise; and low noise block down converter gain, stability, and phase noise. The network owner/operator may provide a list of certified equipment that satisfy the above specifications for joining the network. To bring the subscriber online, the network owner/operator (e.g., via NMC 18) may create an options file for the subscriber, and then send (e.g., mail, e mail, Internet download, etc.) the options file to the subscriber for loading into the subscriber's modem. Once loaded into the modem, the subscriber comes online in the network. Other equipment at the remote site that provides for communication over the satellite network may be selected by the subscriber based on the subscriber's own needs or desires. It may be appreciated, however, that such subscriber devices should also meet certain requirements, and thus, in some embodiments, the network owner or will also provide a list of certified IP devices that will work over the IP network, and may also certify or test IP devices that a user or users wish to use. The network may monitor remote site IP devices, to identify devices at the remote sites to ensure that they are certified or otherwise meet the IP network requirements.

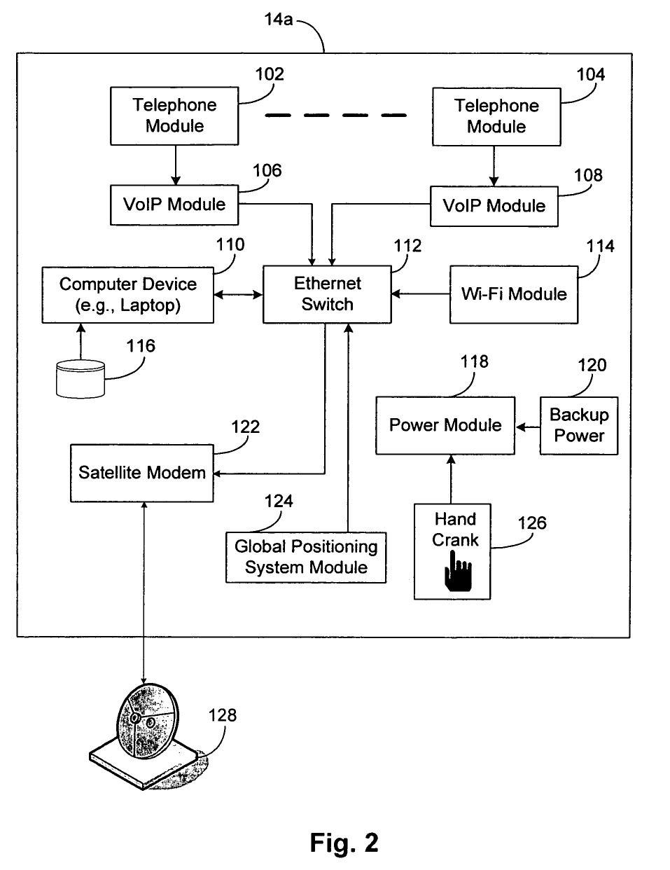

Referring now to FIG. 2, an illustrative remote site (e.g., remote site 14a) is depicted in accordance with an embodiment of the present invention. Remote site 14a may comprise one or more telephone modules such as telephone module 102 and 104, Voice over Internet Protocol (VoIP) module 106 and 108, a computer device 110, an Ethernet switch 112, a wireless module (e.g., Wi-Fi system) 114, a storage device 116, a power module 118, a backup power supply 120, a satellite modem 122, a global positioning system 124, a mechanical drive device for power generation 126, and antenna unit 128 (e.g., dish antenna). In some embodiments, all or a sub-combination (e.g., not including the antenna unit and/or not including a global positioning system, etc.) of these components may be housed in a common chassis that may be compact and/or portable, providing for easy deployment of remote sites. As noted above, however, users having any of a variety of devices (fixed, portable, or mobile, etc.) may subscribe to the network.

Telephone modules 102 and 104 may include any corded or cordless telephone. Each output from telephone module 102 and 104 is coupled to VoIP module 106 and 108, respectively. The output of telephone 102 is converted to a voice over IP format by module 106 for providing, among other things, the capability for transmission over one or more data networks. Similarly, the output of telephone 104 is converted to a voice over IP format by module 108 for also providing, among other things, the capability for transmission over one or more data networks. The output of each of VoIP modules 106 and 108 is coupled to Ethernet switch 112 in order to provide call data associated with telephone modules 102 and 104 to satellite modem 122. At modem 122, the call data is transmitted by antenna 128 to an operable satellite within the satellite communication network based on the options file information which specifies inbound carrier frequency and other information (e.g., datarate).

Computer device 110 may also be connected to satellite modem 122 via Ethernet switch 112. Data, voice, or other content may be sent from computer 122 via Ethernet 112 to satellite modem 122. At satellite modem 122, the data, voice, or other content may be sent to an operable satellite within the satellite communication network. Similarly, other data, voice, or content may be received from the satellite network by modem 122 and sent to computer 110 via. Ethernet 112. Computer device 110 may include a user interface (not shown), which may provide operators of terminal device 14a with the opportunity to configure one or more components within remote site 14a. The configuration of one or more components within remote site 14a may be accomplished by sending configuration data from one or more earth stations to the remote site 14a. At remote site 14a, the configuration data may be received by computer 110 via Ethernet 112. Computer 110 may then transfer the received configuration data to storage memory device 116. A user may review the communication parameters (e.g., bandwidth allocation, transmit/receive frequencies, IP address allocation, hub assignment) associated with satellite modem 122 based on the configuration data stored at memory 116. The sent configuration data may include one or more files each comprising options for, for example, configuring the remote site 14a communication capabilities. Updated configuration data may regularly or on a scheduled basis be transmitted to computer 110 from one or more earth stations. Although, configuration data may be sent over the satellite network, it may also be possible to communicate the configuration data between the one or more earth stations and the remote site 14a via another communication network. For example, a terrestrial data network may exist between one or more earth stations and the remote site 14a. Configuration data that is sent from the earth stations may be received by Ethernet switch 112 over the terrestrial data network (not shown) and stored in memory 116 via computer device 110. Other data networks such as, for example, cellular networks (not shown) may also be used in addition to, or in place of, a terrestrial based data network.

Storage memory device 116 may be utilized to store various data content sent over the satellite communication network. For example, police stations using a remote site device such as remote site 14a may receive training video data over the satellite network. Video content that is received by modem 122 and sent to computer 110 via Ethernet 112 may be stored in memory 116 This may, among other advantages, enable the use of the satellite network to transfer specific data content to users incorporating the remote site within their organization's communication infrastructure.

Wireless module (e.g., Wi-Fi system) 114 may provide users at the remote site 14a with the capability to wirelessly access and transmit data or content via the satellite network using satellite modem 122. For example, one or more computers or other devices may wirelessly establish a communication link with remote site 14a using module 114, whereby the communication link may include encryption for allowing authenticated users access to the remote site 14a. The received data at wireless module 114 may then be sent to satellite modem 122 via Ethernet switch 112. At satellite modem 122, the received data is transmitted over the satellite communication network (e.g., earth station, internet, etc.).

Remote site 14a may also include a global positioning module 124 such as a GPS receiver that calculates the geographical position of the remote site device 14a. This positional information may be stored locally in memory 116. Additionally, the positional information may be sent over the satellite network for storage at a remote server or location (e.g., Network Management Center) where the remote site devices within the satellite communication network are monitored and/or managed.

The remote site 14a may be powered by power module 118. Power module 118 may control the generation and distribution of power generated by a plurality of power supply devices such as, for example, mechanical power generation device 126 and backup power supply device 120. Mechanical power generation device 126 may be comprised of a hand crank that is used for providing mechanical motion for facilitating electrical power generation. Backup power supply device 120 may include an auxiliary power supply comprising rechargeable battery cells, fuel cells, a solar energy based electrical power generation system, or any other type of device capable of generating and delivery electrical power to power module 118. Through the use of mechanical power generation device 126, power module 118 forms a self-sustaining electrical power generation apparatus that is capable of generating electrical power in the event of emergencies, where access to other sources of power (e.g., power grid, delivery of battery packs) is not possible. For example, backup power 120 may comprise an array of rechargeable batteries that is recharged by electrical power provided from a power outlet. In the event that electrical power from the main grid is down, the power outlet is unable to recharge the battery array. Under these conditions, power generation may be possible via mechanical power generation device 126.

In accordance with some embodiments of the present invention, remote sites may also store a backup options file designating the inbound and outbound carrier frequencies of the overflow network. In the event that remote loses communications via the primary link for a predetermined period of time, the remote may load the backup options file, and reset itself. Upon reset, the remote will lock onto the overflow link 72.

In accordance with an embodiment of the present invention as illustrated in FIG. 1, it may be understood that the satellite communications network provides for geographic hub diversity, using two geographically diverse earth stations 12 and 14 (e.g., on the east coast and west coast of US, respectively) under control and management of a common NMS 24 to provide a multi link network comprising remote sites managed under NMS 24. Such hub diversity protects against complete hub failure, for instance, in event that one of the earth stations suffers damage (e.g., protocol processor failure, etc.). Additionally, in some embodiments, the geographically diverse hub may be advantageously used in provisioning remote sites. For instance, a subscribing entity (e.g., a corporation) may have multiple remote sites, and in such a case, the remote sites for the entity would be distributed between or among geographically diverse earth stations. More specifically, by way of example, assuming remote sites 14a and 14b were deployed at one or more premises of a specific company, these remote sites would be configured, as shown, for communication with earth stations 14 and 12, respectively.

In accordance with a further embodiment of the present invention as illustrated in FIG. 1, one or more remote sites may be moved from link 68 or link 70 to overflow link 72 to provide load balancing and/or to prevent or mitigate congestion on links 68 and 70, ensuring that remote sites can access the network via these links, and can obtain additional bandwidth as may be needed, for instance, in emergency situations.

The decision to move one or more remote sites to the overflow link may result from a variety of conditions. For instance, in accordance with some embodiments of the present invention, the NMS proactively monitors conditions that are visible to an operator at NMC 18, or which may cause NMS 24 to prompt an alarm condition at NMC 18. For instance, as noted above, if a predetermined threshold for protocol processor CPU utilization is exceeded (e.g., indicating that the protocol processor is approaching its modem handling limit), then NMS triggers an alarm at the NMC via backbone network 62. An operator at NMC 18, via NMS 24, can then reassign one or more remote sites to the overflow link 72 to relieve congestion. Alternatively, or additionally, additional bandwidth may be demanded by one or more remote sites on links 68 and/or 70, and an operator at NMC 18 may determine that other remote sites should be moved to the overflow link to make the bandwidth available without causing congestion. NMS 24 provides a platform such that the operator at NMC 18 can move one or more remote sites to the overflow link by dragging icons representing the remote site(s) into a folder representing link 72. The operator may also actively edit the options file to set the inbound and outbound carrier frequencies to those of the overflow link 72, as well as to change any other parameters (e.g., QoS, CoS, etc.).

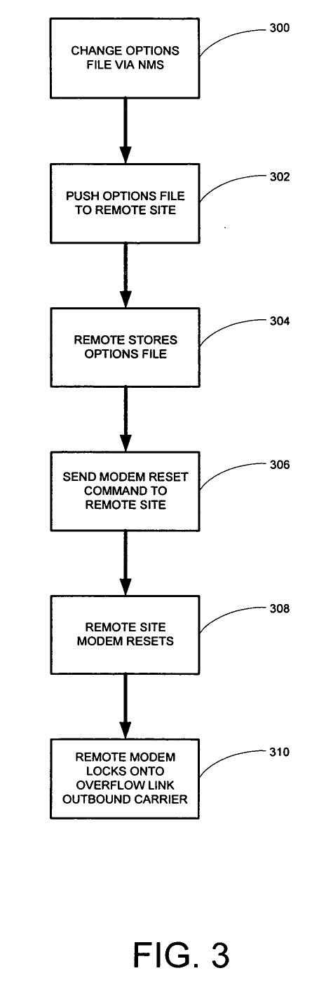

FIG. 3 shows an operational flow diagram illustrating a sequence of events that occur in moving a remote site from link 68 or 70 to overflow link 72. Either by a manual change made by the operator, or as a result of the operator dragging the remote site icon into a folder for overflow link 72, the options file of the remote site is changed via NMS 24 to update the frequency assignment (step 300). Then, the options file is pushed to the remote site via a channel on the current outbound carrier to which the remote site modem is tuned (step 302), with the remote site storing the updated options file (step 304). Then, via NMS 24, a modem reset command is sent to the remote site via the current outbound carrier (step 306). Upon the remote site modem resetting itself (step 308) in response to the command, the remote site modem locks onto the outbound carrier for overflow link 72, and is thus communicatively coupled to earth station 14.

It is noted that link 72 may be on the same or on a different transponder from link 68 and/or link 70, and that link 72 could be provided by another geographically diverse earth station (not shown) under control of NMS 24. By moving remote sites to the overflow network, congestion on link 68 and/or link 70 may be prevented or mitigated. Also, additional bandwidth may be made available for allocation to remote sites that may need such bandwidth in an emergency situation. It is noted that in alternative implementations, NMS 24 may automatically invoke reallocation of remote sites to the overflow link, without operator invocation or intervention.

Proactive monitoring of individual remote site usage (e.g., implementing a packet sniffer at server 32 and server 52) may be used to detect excessive bandwidth usage (e.g., average bandwidth usage over predetermined time interval), and to alarm NMC 18 accordingly. In response, an operator may contact the remote site and determine whether additional bandwidth is needed (e.g., for an emergency). The operator may then provide the needed bandwidth to the remote site by updating the CoS parameters in the options file of the remote site. It may be understood, therefore, that the system provides for a variety of mechanisms for providing subscribers eligible for and/or requiring additional bandwidth with additional bandwidth, such as by reassigning users, reallocating resources, and/or reallocating available bandwidth.

The network may also proactively monitor individual components throughout the network (e.g., based on IP address), including at the remote sites, alarming NMC 18 in the event, for example, that a threshold is exceeded or a device is inoperable or nonresponsive. Such proactive monitoring may be controlled and initiated at NMC 18, for example, by intermittently or periodically pinging devices via NMS 24, though components may be configured to sua sponte notify NMS 24 in the event of certain failure conditions.

In accordance with a further embodiment of the present invention, earth stations 12 and 14 are operative in re-routing remote site communications via the backbone network 62 in the event that the remote site communication cannot be completed at the originating earth station. For instance, referring to FIG. 1, if remote site 14b places a phone call and earth station 12 cannot complete the call either over the Internet via gateway 30 or over PSTN 61 via VoIP/PBX gateway 28, then the call will be redirected via backbone network 62 to earth station 14, which will complete the call via VoIP/PBX gateway 48 or via gateway 50. Similar backbone re-routing may be performed for other remote site communications (e.g., data, video communications over Internet 60).

In view of the foregoing illustrative embodiments, it is understood that providing one or more overflow links and the capability for moving remote terminals to (and from) such overflow links (allowing, for example, for load balancing, congestion mitigation, and assured access) does not require a network configuration having geographic hub diversity. That is, geographic hub diversity and one or more overflow links may be implemented individually or in combination. For instance, in accordance with some embodiments of the present invention, FIG. 3 depicts an illustrative satellite communications network comprising earth stations 13 and 15, satellite 17, remote sites 17a, 17b . . . 17n, and including primary links 67 and 71, as well as overflow links 73 and 77. For convenience and clarity of exposition, many of the components that may be functionally and/or structurally similar to those in the embodiment depicted in FIG. 1 are identified by the same reference numerals. As shown, in this embodiment, earth station 13 and earth station 15 have respective network management systems, NMS 23 and 25, both of which are communicatively coupled to and accessible by NMC 18 (e.g., for alarming NMC 18, for NMC to monitor and/or control devices and remote sites associated with earth stations 13 and 15. As depicted, under control and management of NMS 23, earth station 13 provides for communication with one or more remote sites by transmission to and reception from satellite 17 via primary link 71 and overflow link 77. Similarly, under control and management of NMS 25, earth station 15 provides for communication with one or more remote sites by transmission to and reception from satellite 17 via primary link 67 and overflow link 73. Each of links 67, 71, 73, and 77 represents a distinct link comprising both the outbound (from earth station to remote) and inbound (from remote site to earth station) frequency channels used to communicate with remote sites assigned to the links. As shown for purposes of illustration, remote site 17a is assigned to and in communication with earth station 15 via link 67, whereas remote sites 17b and 17n are each assigned to and in communication with earth station 13 via primary link 71.

In accordance with the illustrative embodiment depicted in FIG. 3, one or more of remote sites 17a, 17b . . . 17n may be moved to any of the overflow links 73 and 77 and/or to a different one of primary links 67 and 71, for instance, as may be needed or advantageous for relieving or preventing congestion, providing assured access, or otherwise reallocating remote sites. Such a decision may be based, for example, on proactive monitoring of individual usage and/or protocol processor CPU usage (e.g., as described hereinabove in connection with FIG. 1). Remote site reassignment may be implemented by NMC 18 pushing an updated options file to the remote site via the satellite communications network. Thus, for example, according to such a process, remote site 17a may be moved from link 67 to any one of the following links: overflow link 73 (within the same earth station), primary link 71, and overflow link 77. Similarly, for example, remote sites 17b and 17n may each be moved from link 71 to any one of the following links: overflow link 77 (within the same earth station), primary link 67, and overflow link 73. It is understood that information stored in NMS 23 and/or NMS 25 is updated via NMC 18 to reflect the reassignment of remote sites.

As noted above, such a network as depicted in FIG. 3. may be implemented separately from or in various combinations with the network configuration shown in FIG. 1. For instance, earth stations 13 and 15 (and their links 67, 71, 73, 77) may be distinct from earth stations 12 and 14 (and their links 68, 70, 72), and satellite 17 may be a distinct from or the same as satellite 16, with NMC 18 being common to each of earth stations 13, 15, 12 and 14. By way of further example, earth station 15 may be distinct from earth station 14, while earth station 13 and earth station 12 may be the same earth station, with link 70 being the same as link 71, and this earth station (i.e., 12, 13) also configured to include overflow link 77. Thus, this latter example would comprise two geographically diverse earth stations (earth station 12/13 and earth station 14 having a common NMS) as well another earth station 15 having its own NMS, all being communicatively coupled to NMC 18, and allowing for movement of remote sites among the links provided by each of the earth stations. In view of the foregoing illustrative embodiments and illustrative variations thereof, those skilled in the art will understand that the overflow topologies in accordance with some embodiments of the present invention may be implemented according to other configurations and combinations of geographically diverse earth stations and one or more other earth stations employing overflow networks.

It may be understood that embodiments of the present inventions provide for an emergency network that is available and used for emergency situations. The emergency network acts as an insurance policy against loss of primarily used communications systems, and is therefore, under such circumstances, not intended to supplant other networks for normal communications usage. In some embodiments, the network owner/operator, which preferably owns the satellite (and typically other satellites) and is not limited by leasing requirements, dedicates satellite bandwidth for the emergency network, this emergency network bandwidth not to be used or shared with other networks. As the emergency network subscription increases, additional networks may be added, and additional satellite bandwidth may be readily dedicated, to provide user's with assured rapid access in case the network is needed. As described further hereinbelow, subscribers may be provisioned across different links and/or different networks such that users (e.g., including emergency services) within local geographic regions (particularly those in high risk areas, such as high hurricane risk) benefit from diversity (e.g., link, hub, network).

Usage based billing schemes or cost structures may be employed as a disincentive for regular use, as server 32 may provide for monitoring and billing of individual usage (e.g., total Mbits per month; datarates used, etc.). The pricing scheme may be established relative to the cost of other communications network services providers (e.g., for voice and/or data communications) such that users will be disinclined to use the emergency satellite network other than in the case of an emergency where other communication network services are inoperable, congested, or otherwise compromised. While cost may provide a disincentive for use, alternatively or additionally, the non emergency usage of the system may be limited by configuring remotes with a limited datarate for inbound (e.g., 64 kB/s) and/or outbound (e.g., 500 kB/s) communications. Similarly, the limited datarate may be established relative to the performance (e.g., bandwidth) of other communications network services providers (e.g., for voice and/or data communications) such that users will be disinclined to use the emergency satellite network other than in the case of an emergency where other communication network services are inoperable, congested, or otherwise compromised. In the event that a subscriber needs additional bandwidth, the subscriber would contact an operator at the NMC (e.g., via phone, e-mail, within or without the emergency network), and specifically request additional bandwidth. Alternatively, in the event that individual usage exceeds a predetermined threshold, then NMC may be alarmed by NMS, and thus an operator may contact the subscriber to ascertain whether additional bandwidth is necessary. Upon approval of the need for additional bandwidth, the NMC operator would modify the subscriber's options file (e.g. changing the CoS to 256 kB/s inbound and 1.5 MB/s outbound) and send the subscriber the updated options file along with a modem reset command.

Regardless of whether or not bandwidth is initially provisioned to a lower amount, consonant with the foregoing discussion of the ability of the network owner/operator providing and expanding dedicated bandwidth to the emergency network as needed, it is understood that the emergency network provides users with burstable bandwidth as demanded or needed by the user. For instance, in an emergency situation, one or more users may require more than 1 Mb/s outbound bandwidth (e.g., 1.5 Mb/s or even greater) and possibly, for example, 512 Mb/s or greater inbound bandwidth. Based on the network operator's/owner's control over system configuration features such as the dedicated bandwidth, the overflow network, user link assignments, etc., the network operator/owner may provide users with reliable, burstable bandwidth at or readily exceeding 1 Mb/s outbound and 512 Mb/s inbound.

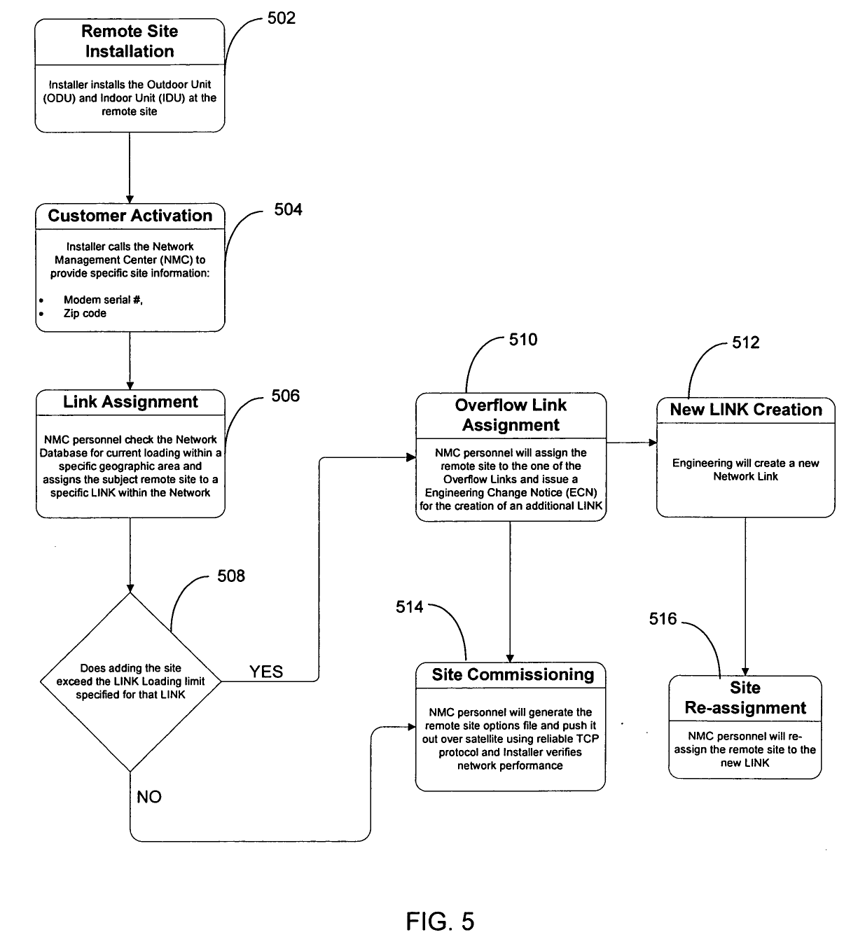

As indicated hereinabove, subscribers may be provisioned across different links and/or different networks such that users (e.g., including emergency services) within local geographic regions (particularly those in high risk areas, such as high hurricane risk) benefit from diversity (e.g., link, hub, network). FIG. 5 depicts an illustrative process flow for installing remote sites in accordance with such principles, in accordance with some embodiments of the present invention. It is understood, however, that remote sites may be reallocated according to similar principles and methods.

Upon subscription by a user, an installer installs an outdoor unit (e.g., VSAT and RF front-end) and an indoor unit (e.g., modem, VoIP gateway, etc.) at the remote site (step 502), appropriately pointing the antenna, and testing the on-site connections and equipment. The installer contacts the NMC to provide specific information identifying the remote site equipment (e.g., modem serial number) and its location (e.g., by zip code), (step 504).

Based on the geographic location of the remote site, an operator at the NMC assigns the remote site to a specific link within the network (step 506). More specifically, in accordance with some embodiments of the invention, to determine which link the remote site should be assigned, the operator accesses a network database that includes, for example, information as to the loading of individual links, including the loading of individual links by remote sites within various geographic domains. Different geographic regions may be assigned or otherwise associated with different degrees of risk (e.g., weather risk based on historical and/or statistical information available from third parties and/or otherwise aggregated or accessed by the network operator/owner). The number and diversity of links, hubs, etc. assigned to geographic areas, and similarly, the distribution or concentration of remote sites within a given geographic area among different links, and/or the maximum number per link, may be established as a function of statistical risk(s) or metrics associated with that geographic area. Assignment of the remote site to a link by the operator may based on this information to provide load balancing that is dependent on geographic risk factors.

In the event that adding the remote site to the link exceeds a predetermined link loading limit, (step 508), NMC 18 will notify the operator, and the NMC operator will assign the remote site to another link, such as an available overflow link, and may also issue an engineering change notice (ECN) requesting or otherwise identifying a need for creating an additional link for servicing the geographic area (step 510). To assign the remote site to the overflow link, NMC 18 will generate an options file and push this file to the remote site via the satellite communications network (using TCP/IP protocol to ensure reliable delivery), and the installer verifies operation of the remote site (step 514). Then, upon creation of a new link (step 512), the NMC operator will reassign the remote site to the new link (e.g., from the overflow link to which the remote site was temporarily assigned) by pushing an updated options file to the remote site.

In step 508, in the event that that adding the remote site to the link does not exceed a predetermined link loading limit, NMC 18 will generate an options file and push this file to the remote site via the satellite communications network (using TCP/IP protocol to ensure reliable delivery), and the installer verifies operation of the remote site (step 514).

Accordingly, it may be understood that in accordance with some embodiments of the present invention, network load balancing may include commissioning remote terminals into the network based on geographic regions, limiting the number of remote sites of the same geographic region in one particular link, to avoid link congestion during actual emergency use, and such limits may be based on statistical information concerning the geographic regions (e.g., hurricane risk). Accordingly, using a geographic database, the network operator may, for example, assign remote terminals within a geographic area among different links (e.g., geographically diverse hubs). Such a geographic database will suggest link assignments using analyses of historical data on probable disasters and current network link density profiles.

Accordingly, in view of the foregoing illustrative embodiments, it may be appreciated that in accordance with various embodiments of the present invention, an emergency satellite communication network may be provided as an always on, but not always used network, providing for assured communications under a variety of emergency conditions.

Systems and modules described herein may comprise software, firmware, hardware, or any combination(s) of software, firmware, or hardware suitable for the purposes described herein. Software and other modules may reside on servers, workstations, personal computers, computerized tablets, PDAs, and other devices suitable for the purposes described herein. Software and other modules may be accessible via local memory, via a network, via a browser or other application in an ASP context, or via other means suitable for the purposes described herein. Data structures described herein may comprise computer files, variables, programming arrays, programming structures, or any electronic information storage schemes or methods, or any combinations thereof, suitable for the purposes described herein. User interface elements described herein may comprise elements from graphical user interfaces, command line interfaces, and other interfaces suitable for the purposes described herein. Except to the extent necessary or inherent in the processes themselves, no particular order to steps or stages of methods or processes described in this disclosure, including the Figures, is implied. In many cases the order of process steps may be varied, and various illustrative steps may be combined, altered, or omitted, without changing the purpose, effect or import of the methods described.

Accordingly, while the invention has been described and illustrated in connection with preferred embodiments, many variations and modifications as will be evident to those skilled in this art may be made without departing from the scope of the invention, and the invention is thus not to be limited to the precise details of methodology or construction set forth above as such variations and modification are intended to be included within the scope of the invention.

What is claimed is:

1. A satellite communication network, comprising:
a satellite;
a network management system operative in controlling and managing a plurality of first terminals and a plurality of second terminals;
a first earth station providing a first communication link via the satellite for bidirectional communication between the first earth station and the plurality of first terminals assigned to the first earth station by said network management system; and
a second earth station geographically diverse from said first earth, the second earth station providing a second communication link via the satellite for bidirectional communication between the second earth station and the plurality of second terminals assigned to the second earth station by said network management system.

2. The satellite communication network according to claim 1, wherein said second earth station further provides a third communication link, wherein one or more of the first and second terminals are capable of being reassigned to said third communication link.

3. The satellite communication network according to claim 2, wherein the first earth station and the second earth station are each communicatively coupled to at least one terrestrial communications network.

4. The satellite communication network according to claim 3, wherein one or more of the first and second terminals are assigned to the third communication link to provide access with assured quality of service to the first link by each of the remaining first terminals, such that each of the remaining first terminals is assured of bidirectional communication over said at least one terrestrial communications network.

5. The satellite communication network according to claim 1, wherein the first and second earth stations include protocol processors, and wherein one or more of the first and second terminals are reassigned to the third communication link in the event that the corresponding protocol processor usage exceeds a predetermined threshold.

6. The satellite communication network according to claim 1, wherein the first earth station and the second earth station are each communicatively coupled to at least one terrestrial communications network.

7. The satellite communication network according to claim 6, wherein each of the first and second earth stations is communicatively coupled to each at least one terrestrial communications network by a plurality of gateways, and wherein in the event that one of the plurality of gateways is non-operational, a communication path is capable of being rerouted to an operational gateway.

8. The satellite communication network according to claim 1, wherein a plurality of fixed terminals are located at emergency services sites.

9. The satellite communication network according to claim 1, wherein at least one of the first terminals is operative in receiving private video content via said satellite, storing said content on the local storage, and serving the private video content to devices via a local broadband wireless network access port.

10. The satellite communication network according to claim 1, wherein the first and second terminals include terminals associated with a plurality of distinct entities, a private network thereby being shared by distinct entities.

11. The satellite communication network according to claim 1, wherein the satellite communication system provides guaranteed access by said first and second terminals to at least one designated emergency control center.

12. The satellite communication network according to claim 11, wherein at least one of the designated emergency control centers is implemented as one of said first terminals.

13. The satellite communication network according to claim 12, wherein at least one of the designated emergency control centers is implemented as a node on at least one terrestrial network communicatively coupled to at least one of said first and second earth stations.

14. The satellite communication network according to claim 1, wherein additional bandwidth can be selectively provided on demand to one or more of the first and second terminals.

15. The satellite communication network according to claim 1, wherein operation of the satellite communication network is proactively monitored.

16. The satellite communication network according to claim 15, wherein each of the first and second earth station includes at least one protocol processor, and monitoring includes monitoring of each of the protocol processor CPU utilization.

17. The satellite communication network according to claim 15, wherein proactive monitoring includes monitoring inbound and outbound bandwidth for each terminal in the network.

18. The satellite communication network according to claim 15, wherein proactive monitoring includes monitoring of alarm conditions of each terminal in the network.

19. The satellite communication network according to claim 15, proactive monitoring includes the status of intemetworking systems for coupling the earth stations to at least one terrestrial network.

20. The satellite communication system according to claim 1, wherein said plurality of first and second terminals include a plurality of stations having a housing, within said housing each of the stations comprising:
a transceiver providing for bidirectional communication via the first communication link;
a computer operative in presenting a user interface allowing for a user at the fixed station to communicate via the first communication link;
local storage;
at least one VoIP port to provide VoIP communication via the first communication link;
a local broadband wireless network access port that provides for authorized devices within range of the wireless network access port to communicate with the at least one terrestrial communication network via the first communication link and with each other;
a security module operative in authenticating devices for communication via the wireless network access port; and
a locally stored configuration profile remotely accessible and reconfigurable by said network management system.

21. The satellite communication system according to claim 20, wherein each of the stations further comprises a battery that is capable of supplying the power requirements of the fixed station.

22. The satellite communication system according to claim 21, wherein each of the stations further comprises a manually operated generator that is capable of supplying the power requirements of each of the fixed stations.

23. The satellite communication system according to claim 20, wherein each of the stations is portable.

24. A portable terminal device, comprising:
a transceiver providing for duplex communication with a satellite communication network that provides a broadband outbound channel to the portable terminal device;
a computer operative in presenting a user interface allowing for a user at the terminal device to communicate via the satellite communication network;
local storage;
at least one VoIP port to provide VoIP communication via the satellite communication network;
a local broadband wireless network access port that provides for authorized devices within range of the wireless network access port to communicate via the satellite communication network and with each other;
a security module operative in authenticating devices for communication via the wireless network access port; and
a locally stored configuration profile remotely accessible and reconfigurable by a network controller associated with the satellite communication network.

25. The portable terminal device according to claim 24, further comprising a battery that is capable of supplying the power requirements of the portable terminal device.

26. The portable terminal device according to claim 25, further comprising a manually operated generator that is capable of supplying the power requirements of the portable terminal device.

27. The portable terminal device according to claim 24, wherein the portable terminal device is operative in receiving private video content via said satellite network, storing said content on the local storage, and serving the private video content to devices via the local broadband wireless network access port.

28. A satellite communication network, comprising:
a satellite;
a network management system operative in controlling and managing a plurality of terminals;
an earth station providing a first communication link via the satellite for bidirectional communication between the earth station and the plurality of terminals assigned to the first earth station by said network management system; and
a second communication link under control of said network management system, wherein one or more of the terminals are capable of being reassigned to said second communication link by the network management system.

29. The satellite communication network according to claim 28, wherein the second communication link is provided by a second earth station that is geographically diverse from said earth station.

30. A method for providing a satellite communications network, the method comprising:
providing dedicated bandwidth on one or more satellites for the satellite communications network;
providing a subscriber to said satellite communications network with access to the network such that the subscriber has a disincentive for using the satellite communications network.

31. The method according to claim 30, wherein said providing subscriber access to the network comprises providing the subscriber with a limited bandwidth relative to other communications networks over which the subscriber may communicate, thereby providing the disincentive.

32. The method according to claim 31, further comprising changing the limited bandwidth to an increased bandwidth in response to a demand.

33. The method according to claim 32, wherein changing the limited bandwidth to an increased bandwidth comprises:
generating an updated options file for use by a modem associated with the subscriber, said updated options file including increased outbound bandwidth and/or inbound bandwidth; and
sending said options file to said subscriber for loading into said modem.

34. The method according to claim 32, wherein changing the limited bandwidth to an increased bandwidth is performed in response to a request initiated by the subscriber.

35. The method according to claim 32, wherein changing the limited bandwidth to an increased bandwidth is initiated by the satellite communications network in response to the satellite communications network detecting usage by the subscriber exceeding a predetermined threshold.

36. The method according to claim 30, wherein the subscriber is capable of being provided with outbound burstable access and/or inbound burstable access at datarates as needed by the subscriber.

37. The method according to claim 36, wherein the subscriber is capable of being provided with burstable access at least about 1.0 megabits per second outbound and at least about 500 megabits per second inbound.

38. The method according to claim 30, wherein the subscriber is provided with access to said network according to a usage based fee structure.

39. The method according to claim 38, wherein the usage based fee structure is a function of one or more of total data transferred within a billing cycle, inbound datarate, and outbound datarate.

40. The method according to claim 38, wherein the usage based fee structure is established relative to the cost of other communications network services providers that may be available to the subscriber, thereby providing the disincentive.

41. The method according to claim 30, wherein the subscriber is capable of being provided access to the network independent of providing the subscriber with a specific device used by said subscriber for communicating via the satellite communication network, provided that the subscriber has compatible interface equipment for communicating with the satellite communications network, and the one or more devices used by the subscriber are compliant with data communications protocols and requirements for the satellite communications network.

42. A method for providing a satellite communications network, the method comprising:
providing dedicated bandwidth on one or more satellites for the satellite communications network;
providing a subscriber to said satellite communications network with access to burstable bandwidth; and
charging the subscriber according to a usage based fee structure for burstable bandwidth.

43. A method for providing a satellite communications network, the method comprising:
providing dedicated bandwidth on one or more satellites for the satellite communications network; providing a subscriber to said satellite communications network with access to burstable bandwidth, wherein the subscriber is initially provisioned with a limited bandwidth relative to other communications networks over which the subscriber may communicate, and wherein the subscriber is eligible to receive additional bandwidth.

44. The method according to claim 43, wherein additional bandwidth is provided to the subscriber in response to a request from the subscriber.

45. The method according to claim 43, wherein additional bandwidth is provided to the subscriber in response to the satellite communications network detecting usage by the subscriber exceeding a predetermined threshold.

46. A method for providing a satellite communications service, the method comprising:
providing dedicated bandwidth on one or more satellites for the satellite communications network;
allocating bandwidth to each of a plurality of subscribers up to a maximum total bandwidth less than the dedicated bandwidth; and
pricing usage of bandwidth by the subscribers as a disincentive for usage of the satellite communications service.

47. The method according to claim 46, further comprising providing additional bandwidth to each subscriber on demand.

48. The method according to claim 47, wherein said pricing includes billing subscribers according to the bandwidth used.

49. In a satellite communication network comprising first and second communication links, each providing for bidirectional communication with a remote terminal via a modem in the remote terminal, a method for moving the remote terminals from the first communication link to the second communication link, the method comprising:
storing information in the remote terminal providing for the remote terminal to communicate via the second link; and
loading the information into the modem of the remote terminal in the event that the remote terminal loses communication via the first link.

50. In a satellite communication network comprising at least one communication links, each communication link providing for bidirectional communication with at least one corresponding remote terminal, a method for assigning a given remote terminal to said at least one communication link, the method comprising:
determining the geographic location of said given remote terminal; and
selectively assigning the remote terminal to a given one of said at least one communication links based at least in part on geographic dependent information for the geographic location.

51. A satellite communication network, comprising:
a satellite;
a first earth station having a first network management system and providing a first communication link via the satellite for bidirectional communication between the first earth station and a plurality of first terminals under management by said first network management system;
a second earth station having a second network management system and providing a second communication link via the satellite for bidirectional communication between the second earth station and a plurality of second terminals under management by said second network management system, said second earth station also providing a third communication link via the satellite for bidirectional communication between the second earth station and remote sites assigned to the third communication link; and
wherein at least one of the first terminals is capable of being reassigned to any one of said second communication link and said third communication link.

52. The satellite communication network according to claim 51, wherein the first earth station includes a fourth communication link for bidirectional communication via the satellite with remote sites assigned to the fourth communication link, and wherein at least one of the first terminals is capable of being reassigned to any one of the second communication link, the third communication link, and the fourth communication link.

53. The satellite communication network according to claim 52, and wherein at least one of the second terminals is capable of being reassigned to any one of the third communication link, the fourth communication link, and the first communication link.
